(19) United States
(12) Patent Application Publication
(10) Pub. No.: US 2007/0244417 A1
(43) Pub. Date: Oct. 18, 2007

(54) Machine for Physical and Mental Preparation of the Body Prior to the Practice of Sports

(76) Inventor: Pere Escriba Nogues, Mora D'Ebre (Tarragona) (ES)

Correspondence Address: WILLIAM COLLARD;COLLARD & ROE, P.C., 1077 NORTHERN BOULEVARD, ROSLYN, NY, 11576, US

(21) Appl. No.: 10/579,188

(22) PCT Filed: Nov. 3, 2004
(86) PCT No.: PCT/ES04/00486

§ 371 Date: Dec. 21, 2006

(30) Foreign Application Priority Data
Nov. 24, 2003 (ES) P 200302742

(51) Int. Cl. A61H 1/00

(52) U.S. Cl. 601/49

(57) ABSTRACT

The invention consists of a machine with a vibrating structure powered by a built-in electric external vibrating motor which moves the entire structure of the machine. The structure consists of a vertical section with tubular edges which curve to form a horizontal rectangular base upon which users place their feet to receive the vibrations. The lower part has four supporting feet, each of which is finished off at the lower end with an anti-vibratory rubber stopper. Between the two parallel vertical bars are further parallel horizontal bars, two of which are used to attach the electric motor. As a result of all the above the machine is capable of providing vibrations and a complete massage from the head down to the feet.

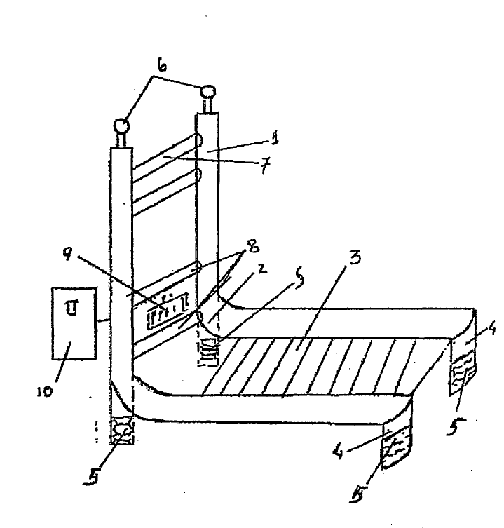

Ever since sport has existed, its adepts have carried out exercises—commonly known as “warm-ups”—consisting of short runs, successive jumping and movements of the arms. It is common to see these movements during football matches, tennis matches and golf competitions.

As a result of this preparation immediately prior to the game, the player's body is duly adapted to the rapid movements it will be required to carry out. However, this practice does not comprise total nor sufficient muscle toning, nor are these movements adequate to produce the relaxation and preparation necessary before commencing the game, free of nerves and with the entire muscular system of the human body ready for action.

An example to demonstrate this is offered by the game of golf, and the well-known and much feared moment of tension surrounding the “FIRST TEE”. This first shot has such an influence that in games between friends it is common to revert to the practice of the so-called “mulligan”, allowing the player to take a second shot without any penalty, given that it is understood that the first shot, due to the nerves of the moment or the numbing of the muscles, is invariably a mishit.

Now, with the invention of the “Machine for physical and mental preparation of the body prior to the practice of sports”, which is currently pending patent applications, there is a solution to this problem which still persists today, offering relaxation and easing of the muscles and the nerves and important benefits for players, even the elderly.

It consists of a vibrating machine which has a built-in external vibrating motor with a system based on the movement of unbalanced masses. Logically, the weights of the masses used need to be suitable for the function which is to be carried out, taking into account that the entire structure of the machine moves without the need for any kind of supporting attachment.

The four supporting legs of the machine are equipped with anti-vibratory rubber stoppers, which keep it fixed and prevent the vibrations from being transmitted to the floor.

Given that the entire structure produces vibrations, any section or part of the same can be used to produce the desired effect.

The machine consists of a vertical rectangular section with tubular parallel edges (1), which then curve (2) to form a horizontal rectangular base (3), upon which the user places their feet to receive the vibrations. Attached to the bottom corners of the base are four vertical supporting feet (4), which are equipped at the bottom end with anti-vibratory rubber stoppers (5).

At the top of the machine are two balls at the end of the tubular edges for users to place their hands and receive the vibrations (6).

These spherical points have been intentionally designed this way so that upon holding the same, the hands receive vibrations on the totality of their surface area.

Furthermore, these balls may be decorated in the form of golf balls, tennis balls, footballs, basketballs, or in any other manner users may wish.

Underneath these balls are hollow cylindrical bars which continue vertically downward in parallel lines. On the upper section of the same are two horizontal bars, one below the other, (7) which users may also take advantage of to receive vibrations, choosing the bar which best suits them according to their height.

At the bottom of the vertical bars are two other parallel horizontal bars (8) between which the electric motor is placed (9). This is equipped with an external vibrator which when activated moves the entire structure without the need for any means of supporting attachment.

Continuing downward, the parallel vertical bars bend forwards, each of them forming a flat horizontal platform or base for users to place their feet and also receive the vibrations.

The empty space in the centre between the horizontal bars of the vertical section of the structure may be used to place the instructions for use of the machine, advertising, drawings, etc.

Attached on the underside of the base on the four corners are the supporting feet for the machine, which are equipped at the bottom end with anti-vibratory rubber stoppers which serve to keep the machine steady and also prevent the vibrations from being transmitted to the floor.

Given that the entire structure of the machine, which is currently pending registration, produces vibrations in any part of the same, it results in a general movement of the entire body, massaging the muscles, activating the circulation and relaxing the nerves.

The machine starts to function after inserting a coin in the deposit (10), thereby activating the power supply to the motor and the timer. In order to facilitate an understanding of the “Machine for physical and mental preparation of the body prior to the practice of sports” a series of diagrams of the machine is also provided.

We do not consider it necessary to make a more extensive description for any expert in the field to understand the implications of this invention and the benefits it offers.

The matters set out in this description should always be understood in their widest sense and not limited in any way.

The materials, shape, size and arrangement of the elements may be subject to variation, provided that this does not comprise an alteration to the essential features of the invention, which are set out in the claims below.

1-8. (canceled)

9. A machine for physical and mental preparation of the body prior to the practice of sports, consisting of a structure which vibrates in its entirety, a vertical and rectangular section with vertical sides or edges consisting of parallel tubular bars which bend at a right angle to form the parallel edges of a horizontal rectangular platform or base for the placing of the feet, which has supporting feet on its underside at the four corners equipped with anti-vibratory rubber stoppers at the ends to keep the machine fixed to the floor and prevent the transmission of vibrations to the same.

10. The machine as described in claim 9, wherein the two parallel vertical tubular bars are each finished off at the top end with a ball or spherical figure which transmits the vibrations in their entirety to the hands which are placed upon them. These spheres may also be decorated.

11. The machine as described in claim 9, wherein between the two vertical tubular bars are two separated parallel horizontal or vertical bars which may be used according to the height of the user to receive the vibrations without losing efficiency.

12. The machine as described in claim 9, wherein below these horizontal bars are another two parallel bars, above which is an empty space which may be used to place a sign with the instructions for use of the machine or any other kind of drawing, including advertising.

13. The machine as described in claim 9, wherein between the two lower horizontal bars an external vibrating motor is attached, which functions based on the movement of unequal masses, in such a way that the weight of the masses is adequate for the function to be carried out.

14. The machine as described in claim 9, wherein below the horizontal bar supporting the motor the vertical parallel bars bend at a right angle to form the base or platform of the machine, which also vibrates to enable application of the machine to the whole body, from head to foot.

15. The machine as described in claim 9, wherein the exterior of each side of the upper section and the exterior of each side of the base or platform is attached by way of diagonal steel bars.

16. The machine as described in claim 9, wherein both the horizontal and vertical structure of the machine is protected by U shaped caps which are screwed to the structure.

17. The machine as described in claim 9, wherein the four feet which support the lower platform or base are each equipped with anti-vibratory rubber stoppers at the bottom ends.

18. The machine as described in claim 9, wherein it may be attached to the floor by placing a horizontal structure on the base with the same dimensions as the underside of the machine, and attachment to the underside of plates equipped with holes for the insertion of screws, with a minimum of four anti-vibratory rubber stoppers being inserted between the two structures to enable the machine to continue carrying out its function of a vibrating structure.

19. The machine as described in claim 9, wherein the motor which produces the vibrations for the entire machine receives the necessary power supply and starts functioning after inserting a coin into a deposit, with a recognition system activating a frequency variator which determines the frequency in hertz and the power supply sent the motor for the duration selected by way of a timer incorporated in the deposit. This deposit is attached independently to the structure to prevent the transmission of vibrations.
